(19) United States
(12) Patent Application Publication
(10) Pub. No.: US 2016/0042865 A1
(43) Pub. Date: Feb. 11, 2016

(54) MULTI-LAYER CERAMIC CAPACITOR

(71) Applicant: SAMSUNG ELECTRO-MECHANICS CO., LTD., Suwon-Si (KR)

(72) Inventors: Kyung Pyo HONG, Suwon-Si (KR); Yo Han SEO, Suwon-Si (KR); Sang Hyun PARK, Suwon-Si (KR); Young Bae KIL, Yongin-si (KR)

(21) Appl. No.: 14/817,804

(22) Filed: Aug. 4, 2015

(30) Foreign Application Priority Data
Aug. 5, 2014 (KR) 10-2014-0100460

(51) Int. Cl. H01G 4/12; H01G 4/248; H01G 4/012; H01G 4/30

(52) U.S. Cl. CPC H01G 4/12; H01G 4/30; H01G 4/248; H01G 4/012

(57) ABSTRACT

The present invention relates to a multi-layer ceramic capacitor which includes a ceramic body on which an inner electrode and a dielectric layer are alternately stacked, a crack prevent layer formed on both sides of the ceramic body and an external electrode covering both ends of the ceramic body on which the crack prevention layer is formed.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2014-0100460, entitled filed Aug. 5, 2014, which is hereby incorporated by reference in its entirety into this application.

### BACKGROUND OF THE INVENTION

1. Field of the Invention

The present invention relates to a multi-layer ceramic capacitor.

2. Description of the Related Art

In general, the electronic components using the ceramic material such as a capacitor, an inductor, a piezoelectric device or the like include a ceramic body made of a ceramic material, an internal electrode formed inside of the ceramic body and an external terminal installed on the surface of the ceramic body so as to be connected to the internal electrode.

The multi-layer ceramic capacitor among the ceramic electronic components includes a plurality of ceramic dielectric sheets, an internal electrode inserted between the plurality of ceramic dielectric sheets and an external electrode electrically connected to the internal electrode.

Such multi-layer ceramic capacitor can implement high electrostatic capacitance with a compact size and can be easily mounted on the substrate, whereby it has been widely used as the capacitive element of various electronic devices.

### SUMMARY OF THE INVENTION

An object of the present invention to provide a multi-layer ceramic capacitor capable of suppressing the generation of cracks in the junction part of the dissimilar materials by intensifying the warpage strength of the multi-layer ceramic capacitor.

The object in accordance with the present invention is to prevent the generation of cracks in the junction part of dissimilar materials due to the warpage deformation of the substrate when the dielectric layer and the external electrode are constructed with dissimilar materials in the multi-layer ceramic capacitor where the external electrode is formed on both ends of the ceramic body stacked thereon the dielectric layers and the external electrode is joined to the substrate by the soldering.

In order to this, since the tensile stress is maximally generated in the junction part of the dielectric layer and the external electrode as the dissimilar material during the warpage deformation of the substrate, the object can be obtained by blocking the progress of cracks generated in the junction part of the external electrode by inserting the same material of the ceramic body or the material different from the ceramic body into a portion of the side surface facing to the ceramic body constituting of the dielectric layer.

Another object of the present invention is to prevent the cracks from being progressed by forming the inner pattern on the side surface facing to the ceramic body or inserting the crack prevention layer having the stacking structure of material having different thermal expansion coefficient and arranging the inner pattern of the crack prevention layer or the stacking interface to have the direction vertical to the internal electrode.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view showing a multi-layer ceramic capacitor in accordance with an embodiment of the present invention;

FIG. 2 is a cross-sectional view cut along a line I-I′ of FIG. 1;

FIG. 3 is a cross-sectional view cut along a line II-II′;

FIG. 4 is a partial exploded view showing a ceramic sheet used in stacking the ceramic body of FIG. 3; and

FIG. 5 is a cross-sectional view showing one example of a co-fired type crack prevention layer in accordance with the embodiment of the present invention.

### DETAILED DESCRIPTION OF THE PREFERABLE EMBODIMENTS

Hereinafter, embodiments of the present invention will be described in detail with reference to the accompanying drawings to easily implement the spirit of the invention to those skilled in the art. Descriptions of well-known components and processing techniques are omitted so as not to unnecessarily obscure the embodiments of the present invention. The following terms are defined in consideration of functions of the present invention and may be changed according to users or operator's intentions or customs. Thus, the terms shall be defined based on the contents described throughout the specification.

And also, the same components and functions are represented by the same reference numerals hereinafter throughout the drawings.

In addition, reference in the specification to “connect” or “connecting”, as well as other variations thereof, means that an element is directly connected to the other element or indirectly connected to the other element through another element.

And also, when terms “comprises” and/or “comprising” used herein do not preclude existence and addition of another component, step, operation and/or device, in addition to the above-mentioned component, step, operation and/or device.

The technical spirit of the present invention is determined by the scope of claims, and the embodiments of the present invention are only examples to efficiently explain the technical spirit of the present invention to those skilled in the art.

Hereinafter, referring to FIG. 1 to FIG. 5, a multi-layer ceramic capacitor and a method for manufacturing the same in accordance with the embodiments of the present invention will be described.

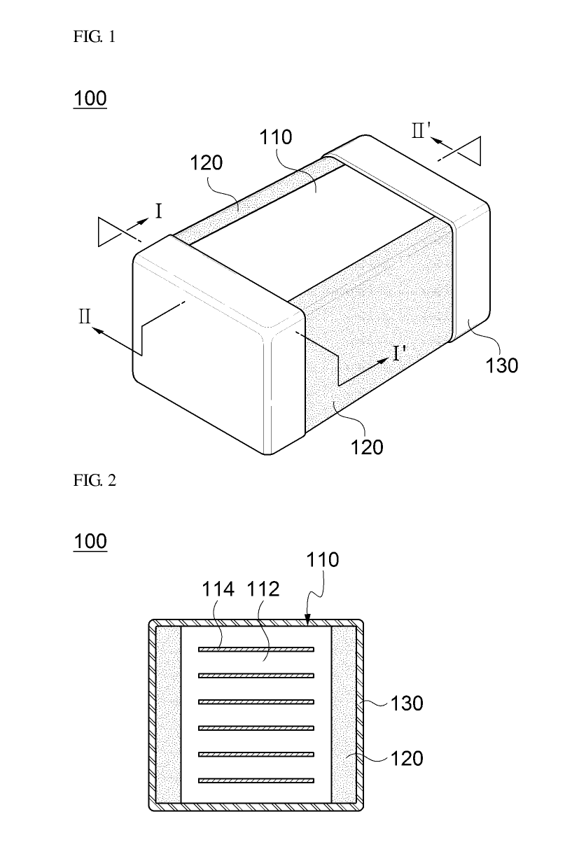

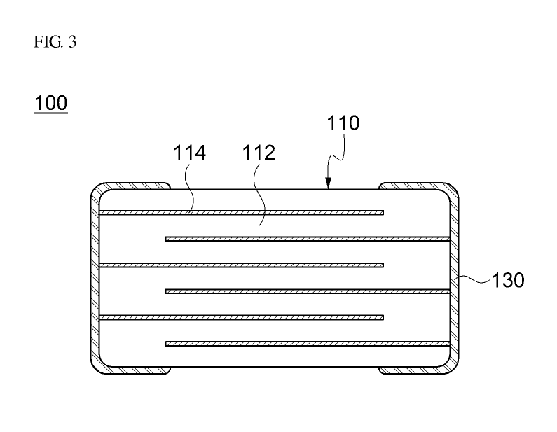

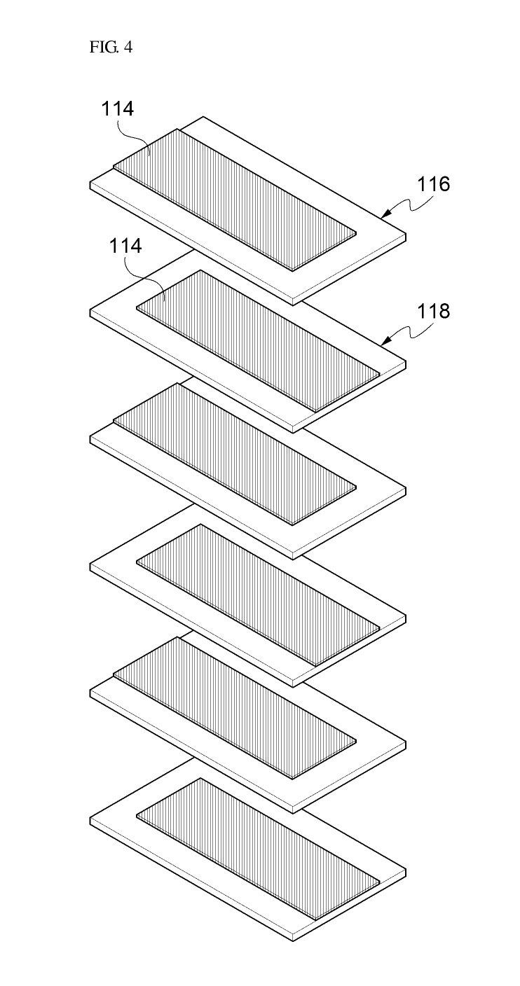

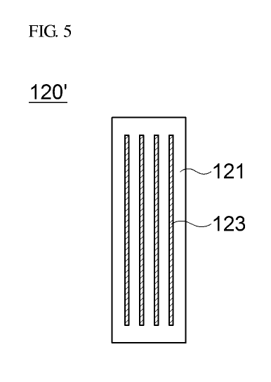

FIG. 1 is a perspective view showing a multi-layer ceramic capacitor in accordance with an embodiment of the present invention, FIG. 2 is a cross-sectional view cut along a line I-I′ of FIG. 1, FIG. 3 is a cross-sectional view cut along a line II-II′, FIG. 4 is a partial exploded view showing a ceramic sheet used in stacking the ceramic body of FIG. 3 and FIG. 5 is a cross-sectional view showing one example of a co-fired type crack prevention layer in accordance with the embodiment of the present invention.

Referring to FIG. 1 to FIG. 3, the multi-layer ceramic capacitor in accordance with one embodiment of the present invention includes a ceramic body 110, a crack prevention layer 120 and an external electrode 130.

A plurality of dielectric layers 112 is stacked inside of the ceramic body 110; and, a plurality of internal electrodes 114 is inserted between the plurality of dielectric layers 112 to thereby form the ceramic body 110.

At this time, the dielectric layer 112 is a ceramic dielectric layer made of ceramic; and, it is a ceramic dielectric sheet manufactured in the sheet of a plate shape.

The ceramic body 110, for example, after the ceramic sheets made of ferroelectric dielectric material such as barium titanate are stacked and pressed, they are finished in a box type through a sintering process, is integrated in a degree that the boundary between the adjacent ceramic sheets does not distinguish. Accordingly, on the drawings, it is shown as one body without distinguishing each ceramic sheet.

As shown in FIG. 3, the internal electrodes 114 may be interposed between the plurality of dielectric layers 112, whereby anodes and cathodes can be alternately arranged.

In this case, after a first ceramic sheet 116 formed thereon the internal electrode 114 so as to expose one end thereof to outside and a second ceramic sheet 118 formed thereon the internal electrode 114 so as to expose the other end thereof to outside are alternately stacked, the ceramic body 110 of FIG. 3 can be formed by sintering the stacked ceramic sheet.

That is, the ceramic body 110 can be formed by stacking the ceramic sheets printed thereon the internal electrodes 114 in plural so as to differentiate the directions of the exposed ends between layers.

The inner electrode 114 may be formed by including a conductive material, e.g., at least one metal selected from a group consisting of Ni, Pd, Al, Fe, Cu, Ti, Cr, Au, Ag, Pt or the like or an alloy thereof.

The internal electrode 114 may be formed, after a conductive paste, e.g., a metal paste, is coated on one surface of the ceramic sheet, into a metal thin film sintered through a sintering process.

Referring to FIG. 1 and FIG. 2 again, the crack prevention layer 120 is formed on both side surfaces including one side surface and the other side surface facing to each other among the peripheral surface of the ceramic body 110, as intensifying the warpage strength of the chip type multi-layer ceramic capacitor 100.

In general, the chip capacitor is mounted on the circuit substrate through a reflow soldering; and, in this case, the warpage is generated in the substrate due to the thermal impact applied to the substrate.

A conventional multi-layer ceramic capacitor generates the crack in the dielectric layer from the end portions of the external electrode due to the tensile stress generated during the warpage deformation of the substrate. The reliability of products may be deteriorated due to the short through the generated crack or the penetration of moisture.

Accordingly, the present invention introduces the crack prevention layer 120 so as to suppress the crack generation in the junction region of the dielectric layer 112 and the external electrode 130 of the multi-layer ceramic capacitor 100 through the warpage deformation of the substrate due to the external impact, particularly to the thermal impact; and, it is described in detail hereinafter.

In particularly, the crack prevention layer 120 of the present invention may be a co-fired type formed by being sintered with the ceramic body 110 at the state of a green chip at the same time.

In this case, the crack prevention layer 120, after the non-sintered crack prevention layers are attached to both side surfaces of the ceramic sheet at the state of green chip, is sintered through the sintering process with the ceramic sheet at the state of green chip at the same time.

The ceramic sheet, after a plurality of green sheets on which the internal electrodes are printed on the dielectric layer stacked and pressed, is formed into the ceramic body 110 through the sintering process.

The sintering process may be performed at the temperature ranging from 1,000° C. to 1,300° C.

After sintering, in order to remove the failure (e.g., the crack) due to the thermal expansion coefficient difference from the ceramic body 110, it is preferable that the crack prevention body 121 as shown in FIG. 5 is made of the same ceramic material of the dielectric layer 112 of the ceramic body 110 as shown in FIG. 2.

For the convenience of manufacturing, it is preferable that the ceramic sheet at the state of green chip for the ceramic body is used as the co-fired type crack prevention layer 120′ as shown in FIG. 5.

In this case, as shown in FIG. 5, the pattern 123 included inside of the crack prevention body 121 is the same material of the internal electrode 114 of the ceramic body 110 as shown in FIG. 2. However, it is preferable that the pattern 123 is arranged so as to have the direction vertical to the inner electrode 114 of the ceramic body 110 in order to suppress the generation of cracks. In this case, if the pattern 123 is formed vertical to the crack progress direction, the progress of cracks can be blocked.

On the contrary, the crack prevention layer 120 of FIG. 2 can be formed by being additionally attached to the ceramic body 110 which finishes the sintering. In this case, the crack prevention layer 120 is attached to the ceramic body 110 at the state of a sintering chip.

The sintering chip can be formed of a non-conductive material, e.g., alumina (Al₂O₃), having the heat resistance to the temperature ranging from 700° C. to 900° C.

The sintering chip must withstand the sintering temperature of the external electrode 130 made of Cu or the like. If the sintering chip cannot satisfy the heat resistance characteristics at the above temperature range, it is difficult to form the crack prevention layer 120 using the sintering chip.

On the other hands, considering on that the thermal expansion coefficient of the dielectric layer 112 formed of a conventional ceramic is about 10 ppm/° C., if the crack prevention layer 120 is a co-fired type or a sintering chip attach type, it can be formed of the material having the thermal expansion coefficient difference with the dielectric layer 112 below 5 ppm/° C. At this time, the present invention has the effect to suppress the generation of failure due to the thermal expansion coefficient difference from the ceramic body 110.

And also, the crack prevention layer 120 can be formed to have the thickness ranging from 20 μm to 200 μm for securing the margin according to the warpage deformation of the circuit board considering on the chip size of the multi-layer ceramic capacitor 100.

At this time, if the thickness of the crack prevention layer 120 is below 20 μm, it is difficult to secure the margin of the warpage strength; whereas, if exceeding 200 μm, it deteriorates the miniaturization of the multi-layer ceramic capacitor 100.

Referring to FIG. 1 to FIG. 3, the external electrode 130 of the present invention is formed on the ceramic body 110 and the crack prevention layer 120 so as to cover both ends of the ceramic body 110.

The external electrode 130 can play the role of an external terminal to electrically connect the external device to the internal electrode 114 by being connected to the internal electrode 114 of which end portions are exposed to the outside the ceramic body 110.

Any one of the pair of external electrodes 130 is connected to the internal electrode 114 of which one end is exposed to the outside of the ceramic body 110, and the other is connected to the internal electrode 114 of which the other end is exposed to the outside of the ceramic body 110.

As one example, the internal electrode 114 connected to the external electrode 130 formed on one side of the ceramic body 110 may be a cathode, and the internal electrode 114 connected to the external electrode 130 formed the other side of the ceramic body 110 may be an anode.

Such external electrode 130 may be formed by including a conductive material, e.g., at least one metal selected from a group consisting of Cu, Ag, Pt or an alloy thereof.

After the external electrode 130 is plated so as to cover both end portions of the ceramic body 110 using a dipping method, it can be formed through a sintering process at the temperature ranging from 700° C. to 900° C.

The external electrode 130 may be also formed in multiple layers by including a nickel (Ni) plating layer, a tin (Sn) plating layer or the like formed using an electroplating, an electroless plating or the like for the solderbility and the corrosion resistance.

In accordance with the present invention, the warpage strength characteristics of the multi-layer ceramic capacitor 100 is intensified by inserting the crack prevention layers 120 and 120′ between the ceramic body 110 and the external electrode 130.

In this result, the present invention can prevent the generation of cracks in the junction part between the ceramic body 110 and the external electrode 130 by alleviating the tensile stress of the multi-layer ceramic capacitor 100 due to the warpage generated in the circuit board by the thermal impact such as the reflow soldering and can prevent the reliability of products from being generated due to the short according to the generation of cracks or the penetration of moisture.

In accordance with the present invention, the multi-layer ceramic capacitor capable of preventing the generation of cracks due to the warpage of substrate by the external impact and the deterioration of product reliability can be provided by intensifying the warpage strength of the chip.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

1. A multi-layer ceramic capacitor:
a ceramic body on which an inner electrode and a dielectric layer are alternately stacked;
a crack prevent layer formed on both sides of the ceramic body; and
an external electrode covering both ends of the ceramic body on which the crack prevention layer is formed.

2. The multi-layer ceramic capacitor according to claim 1, wherein the crack prevention layer is formed by being sintered together with the ceramic body at a state of a green chip at the same time.

3. The multi-layer ceramic capacitor according to claim 2, wherein the crack prevention layer includes a crack prevention body made of the ceramic material of the dielectric layer.

4. The multi-layer ceramic capacitor according to claim 3, wherein the crack prevention layer has a pattern having a direction vertical to the inner electrode in the crack prevention body.

5. The multi-layer ceramic capacitor according to claim 4, wherein the pattern is the same material of the inner electrode.

6. The multi-layer ceramic capacitor according to claim 1, wherein the crack prevention layer is formed by being additionally attached in a state of a sintered chip after sintering the ceramic body.

7. The multi-layer ceramic capacitor according to claim 6, wherein the sintered chip is formed of a non-conductive material having a heat resistance at a temperature ranging from 700° C. to 900° C.

8. The multi-layer ceramic capacitor according to claim 2, wherein the crack prevention layer is formed of a material having a thermal expansion coefficient difference from the dielectric layer below 5 ppm/° C.

9. A multi-layer ceramic capacitor provided with a ceramic body and an external electrode to cover both ends of the ceramic body comprising:
a crack prevention layer formed on both sides of the ceramic body so as to be inserted between the external electrode and the ceramic body.

10. The multi-layer ceramic capacitor according to claim 9, wherein the crack prevention layer is formed by being sintered together with the ceramic body at a state of a green chip at the same time or is formed by being additionally attached at a state of a sintered chip after sintering the ceramic body.

11. The multi-layer ceramic capacitor according to claim 6, wherein the crack prevention layer is formed of a material having a thermal expansion coefficient difference from the dielectric layer below 5 ppm/° C.
